(19) United States
(12) Patent Application Publication
(10) Pub. No.: US 2018/0335527 A1
(43) Pub. Date: Nov. 22, 2018

(54) SYSTEM FOR FASTENING A SCINTILLATOR DEVICE, A SCINTILLATOR THEREOF, AND A METHOD THEREOF

(71) Applicant: SAINT-GOBAIN CERAMICS & PLASTICS, INC., Worcester, MA (US)

(72) Inventors: Michael Lea BUSH, Ravenna, OH (US); Louis PERNA, Elyria, OH (US)

(21) Appl. No.: 15/975,221

(22) Filed: May 9, 2018

Related U.S. Application Data
(60) Provisional application No. 62/508,757, filed on May 19, 2017.

(51) Int. Cl. G01T 1/20; G01T 1/203; G01T 3/06; G01T 7/00

(52) U.S. Cl. CPC G01T 1/2002; G01T 1/2018; G01T 7/00; G01T 3/06; G01T 1/2033

(57) ABSTRACT

An apparatus can include a component, a compression member, and a fastener system. The fastener system can include a first fastening member extending through the compression member and into the component and a second fastening member within the component and coupled to the first fastening member. The apparatus can include a pliable moisture barrier that separates an inner region from an outer region. The component and the second fastening member can be within the inner region, and the first fastening member can be within the inner region and within the outer region.

### CROSS-REFERENCE TO RELATED APPLICATIONS

The present application claims priority under 35 U.S.C. § 119(e) to U.S. Provisional Patent Application No. 62/508,757, filed on May 19, 2017, entitled “System for Fastening a Scintillator Device, a Scintillator Thereof, and a Method Thereof,” naming as an inventor Michael Lea Bush, which is assigned to the current assignee hereof and is incorporated by reference herein in its entirety.

### FIELD OF THE DISCLOSURE

The present disclosure is directed to the arrangement of photosensors on a scintillator and methods of using such scintillators and photosensors in a radiation detector.

### BACKGROUND

Scintillator-based detectors are used in a variety of applications, including research in nuclear physics, oil exploration, field spectroscopy, container and baggage scanning, and medical diagnostics. When a scintillator material of the scintillator-based detector is exposed to ionizing radiation, the scintillator material absorbs energy of incoming radiation and scintillates, emitting the absorbed energy in the form of photons. A photosensor of the scintillator-based detector detects the emitted photons. Radiation detection apparatuses can analyze pulses for many different reasons. Continued improvements are desired.

### BRIEF DESCRIPTION OF THE DRAWINGS

Embodiments are illustrated by way of example and are not limited in the accompanying figures.

FIG. 1 includes an illustration of an apparatus according to an embodiment described herein.

FIG. 2 includes an illustration of a cross section of a component including intersecting openings according to an embodiment described herein.

FIG. 3 includes an illustration of a cross section of an apparatus including fastening members extending into openings in a component according to an embodiment described herein.

FIG. 4 includes an illustration of a cross section of an apparatus including a compression member and an optical interface secured to a component via fastening members extending into openings in a component according to an embodiment described herein.

FIG. 5A includes an illustration of a cross section of an apparatus including a compression member and an optical interface before being secured to a component via fastening members according to an embodiment described herein.

FIG. 5B includes an illustration of a cross section of an apparatus including a compression member and an optical interface before being secured to a component via fastening members according to another embodiment described herein.

FIG. 5C includes an illustration of a cross section of an apparatus including a compression member and an optical interface before being secured to a component via fastening members according to another embodiment described herein.

FIG. 6 includes an illustration of a top view of a portion of the embodiment illustrated in FIG. 1.

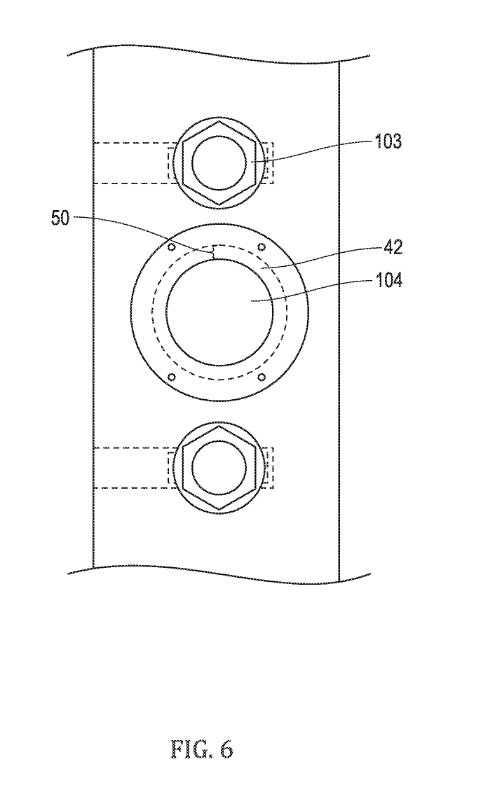

FIG. 7 includes an illustration of a cross section of a moisture barrier disposed on a component according to an embodiment described herein.

FIG. 8 includes an illustration of an analyzer device according to an embodiment described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation detection arts.

An apparatus can include a component, a compression member and a fastening member configured to improve how the compression member is secured. The compression member can maintain compression on a pliable moisture barrier to limit or prevent transmission of moisture into an inner region. A particular advantage embodiments described herein is that the compression member can maintain constant or near constant compression even after exposure to prolonged extreme environmental conditions.

In another aspect, the apparatus can include a radiation detector that includes the component and the fastening members. The radiation detector can further include the pliable moisture barrier. The radiation detector can further include a photosensor and an analyzer device electrically coupled to the photosensor.

Embodiments described below and illustrated are provided to aid in understand the concepts as set forth herein. The embodiments are merely illustrative and not intended to limit the scope of the present invention, as set forth in the appended claims.

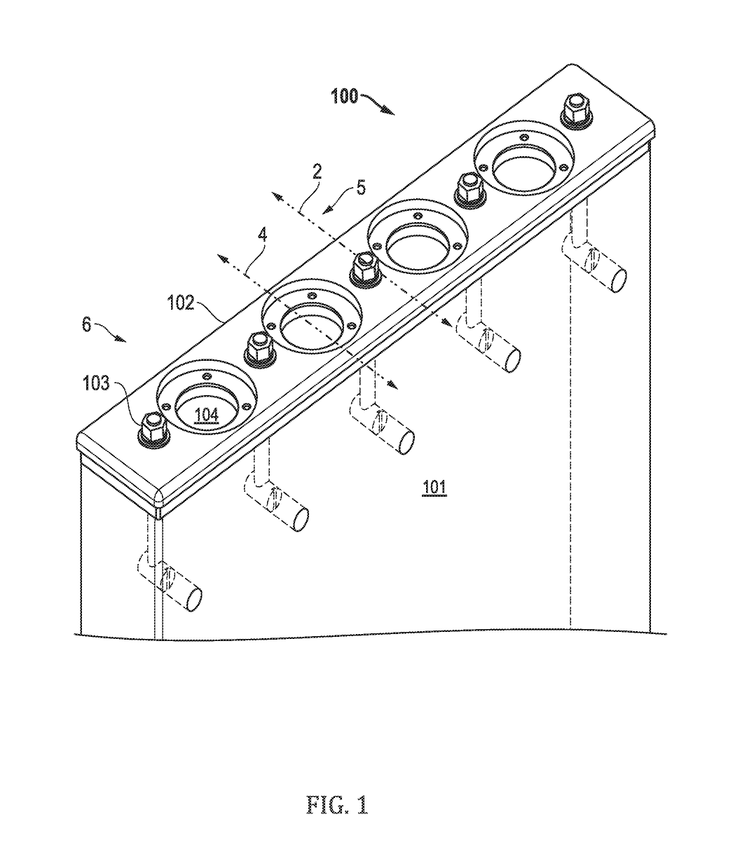

FIG. 1 illustrates an embodiment of an apparatus 100 including a component 101, a compression member 102, a fastener system 103 coupling the compression member 102 to the component 101, and an optical interface 104 disposed at least partly within the compression member 102. After reading this disclosure, one of ordinary skill in the art could include more or fewer of each of the elements illustrated in FIG. 1.

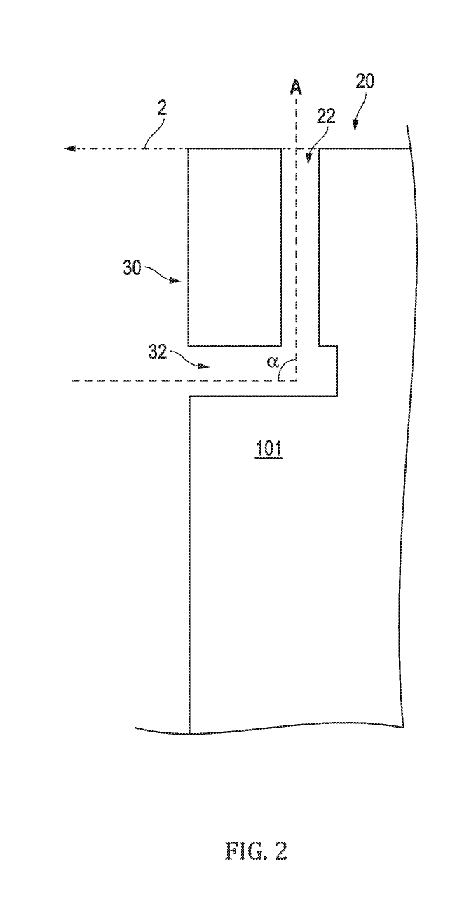

FIG. 2 includes an illustration of a cross section of only the component 101 from FIG. 1, without the compression member 102, the fastener system 103, and the optical interface 104. The cross section is taken along line 2 and viewed from direction 5 (see FIG. 1). As illustrated in FIG. 2, the component 101 includes a surface 20 and a surface 30. The surfaces 20 and 30 can be contiguous, as illustrated in FIG. 1, or separated by at least one other surface (not illustrated). The surfaces 20 and 30 can be perpendicular to each other, as illustrated in FIG. 2, or can lie along planes that intersect at some other angle relative to each other (not illustrated), depending on the desired shape of the component 101.

An opening 22 can extend into the component from the surface 20. An opening 32 can extend into the component from the surface 30. In an embodiment, at least one, or both, of the opening 22 and the opening 32 can include linear channels extending into the component 101. The opening 22 can have a length that is the same or different than the length of the opening 32. In an embodiment, the opening 22 can be longer than the opening 32.

As illustrated in FIG. 2, the opening 22 and the opening 32 can intersect within the component. The opening 22 can intersect with the opening 32 at an angle α. The angle α can include a right angle or an oblique angle, relative to a central axis A of the first opening. In an embodiment, the angle α is at least 75°, or at least 80°, or at least 85°, relative to the central axis A of the first opening. In an embodiment, the angle α is at most 105°, or at most 100°, or at most 95°, relative to the central axis A of the first opening.

In an embodiment, the component can include a water sensitive material. In an embodiment, the component can include a luminescent material. In a particular embodiment, the component 101 can include a scintillator material. The scintillator material can be sensitive to particular types of radiation, for example, gamma rays or neutrons, such that when the material is struck by a particular type of radiation or ionized particle, the scintillator responds by emitting a scintillating light at a particular wavelength. The scintillating light can be captured by a photosensor, such as a photomultiplier tube, a semi-conductor based photomultiplier, a hybrid photomultiplier, or the like, which converts the scintillating light to an electronic signal for processing. As such, a detector can provide a user with the ability to detect and record radiation events, which in the context of security inspection applications, can enable users to detect the presence of radioactive material.

In certain embodiments, the scintillator material can include an inorganic scintillator material, an organic scintillator material, or any combination thereof. In particular embodiments, the scintillator can include a plastic scintillator material. The plastic scintillator material can include an organic scintillator material comprising 2,5-diphenyloxazole, 1,4-bis-2-(5-phenyloxazolyl)-benzene), terphenyl, 1,1,4,4-tetraphenylbutadiene, a tris complex of 2,6-pyridine dicarboxylic acid (dipicolinic acid, DPA), an Ir(mppy)3, an iridium-tris[2-(4-totyl)pyridinato-NC2], a pyrazolate-bridged cyclometalated platinum(II) complex, or any combination thereof. The inorganic scintillator material can include a NaI, a CsI, a SrI2, a LiI, a LiF, a LaBr3, a LaCl3, a CeBr3, a Cs2LiLaBr6, a Cs2LiLaBr6-xClx, a Cs2LiLaBr6-xIx, a Cs2LiYCl6, a Cs2LiYCl6-xBrx, a CsSr2I5, a LiSr2I5, a BaF2, or any combination thereof.

In certain embodiments, the scintillator can include a scintillator compound or a high atomic number compound dispersed in a plastic matrix. The high atomic number compound can include a non-scintillating compound. In particular embodiments, the high atomic number compound can include an element having an atomic number of at least 55, such as in a range of 55 to 118. For example, the high atomic number compound can include a Bi, a Pb, an Jr, a Pt, an Au, or any combination thereof. The plastic matrix can include a transparent polymer. The plastic matrix can include an epoxy, a polyvinyl toluene, a polystyrene, a polymethylmethacrylate, a polyvinylcarbazole, a polybutyrate, a polycarbonate, a polyurethane, a glycol modified polyethylene terphthalate, or any combination thereof.

The component 101 can have a length L of at least 100 cm, 140 cm, or at least 180 cm. In further embodiments, the length L may be no greater than 10 m, no greater than 8 m, or no greater than 6 m. For example, the component 101 can have a volume of at least 4000 cm3, or at least 4500 cm3, or at least 5000 cm3.

In an embodiment, the component 101 can include a plastic material. The plastic material can include a plastic matrix having scintillator particles dispersed therein. In another embodiment, the plastic material can include an organic scintillator material. For example, the organic scintillator material can include a 2,5-diphenyloxazole, 1,4-bis-2-(5-phenyloxazolyl)-benzene), terphenyl, 1,1,4,4-tetraphenylbutadiene, a tris complex of 2,6-pyridine dicarboxylic acid (dipicolinic acid, DPA), an Ir(mppy)3, an iridium-tris[2-(4-totyl)pyridinato-NC2], a pyrazolate-bridged cyclometalated platinum(II) complex, or any combination thereof.

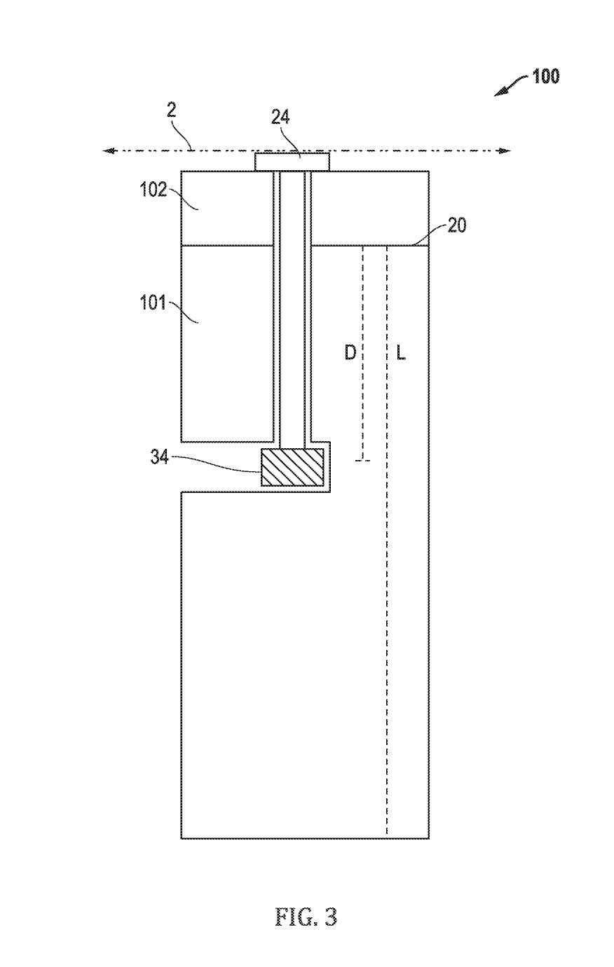

As illustrated in FIG. 3, the fastener system 103 can include a fastening member 24 and a fastening member 34. The fastening member 24 can extend into the component 101 from the surface 20, such as into the opening 22. In an embodiment, the fastening member 24 can include a hard material, such as a metal. In a particular embodiment, the fastening member 24 can include a bolt or a screw. The fastening member 34 can be disposed within the opening 32 of the component 101. For example, the fastening member 34 can be inserted into the component 101 via the opening 32 of the component 101. In an embodiment, the fastening member 34 can include a hard material, such as a metal. In a particular embodiment, the fastening member 34 can include a cross dowel or a nut. Having a multiple fastening member system where fastening members are extending in different directions can provide significantly increased stability to the compression member as opposed to single fastening member systems that are more susceptible to loosening, for example, due to creep deformation of a plastic material.

As illustrated in FIG. 3, the fastening member 24 and the fastening member 34 can contact each other within the component 101. In an embodiment, the fastening member 24 can be coupled to the fastening member 34. For example, the fastening member 24 can have a threaded engagement with the fastening member 34. In a particular embodiment, an end of the fastening member 24 can extend into an opening into the fastening member 34.

The fastening member 34 can have a length that is the same as or different than the fastening member 24. In an embodiment, the fastening member 24 has a length that is greater than the fastening member 34. In an embodiment, the fastening member 24 has a length that is greater than a length of the opening 22. For example, the fastening member 24 can protrude from the component 101 when fastening member 24 is engaged with the fastening member 34. In another embodiment, the fastening member 34 has a length that is less than a length of the opening 32. For example, the fastening member 34 can be completely within the opening 32 when fastening member 34 is engaged with fastening member 24.

The fastening member 24 should extend into the component 101 a sufficient distance so that there is enough of the component material between surface 20 and the fastening member 34 to limit the loosening effect of the creep deformation. For example, the fastening member 24 can extend into the component 101 a distance D from surface 20 that is equal to at least 1%, or at least 2%, or at least 3%, or at least 4% of a total length L of the component measured from the surface 20. The distance D can be at most 30% of a total length L. In an embodiment, the distance D can be at least 2.5 cm, or at least 3.5 cm, or at least 4.5 cm. In an embodiment, the distance D can be at most 10 cm, at most 12 cm, or at most 14 cm.

As illustrated in FIG. 3, the compression member 102 can be disposed on surface 20 of the component 101. In an embodiment, the fastening member 24 can extend into the compression member 102. The compression member 102 can be disposed between surface 20 and an end of the fastening member 24 protruding from the component 101. In a particular embodiment, the fastening member 24 can extend through the compression member 102, into the component 101 via opening 22, and engage with fastening member 34 within the component, to securely hold the compression member in place. The compression member can be formed of a solid material, such as a metal.

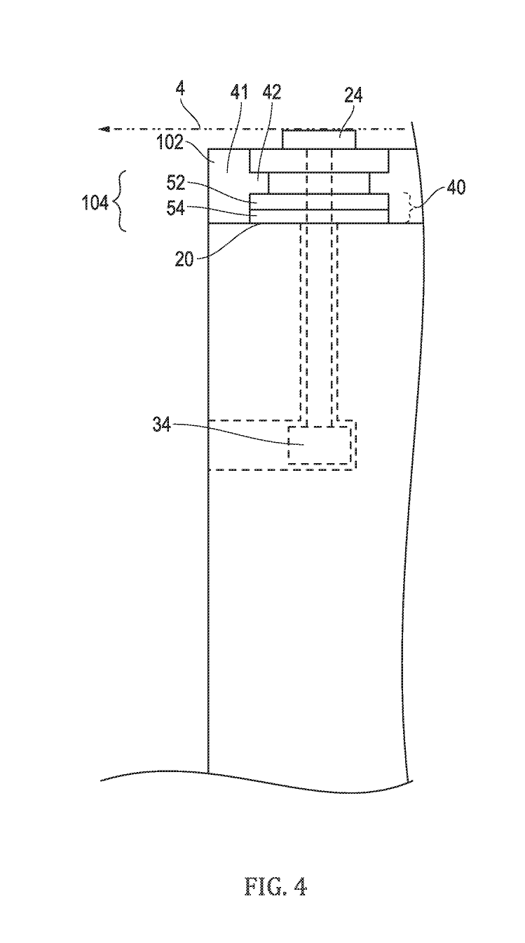

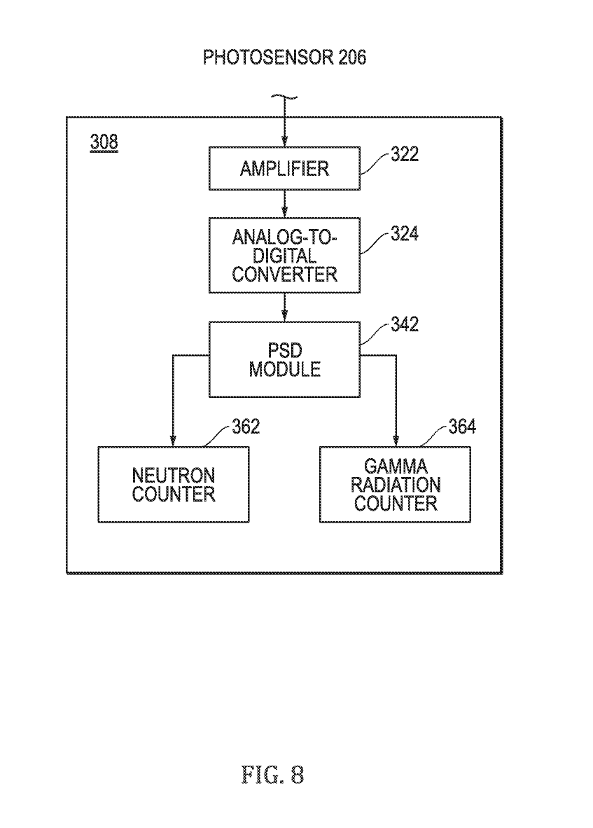

As illustrated in FIG. 4, an optical interface 104 can be disposed on surface 20 of the component 101. The optical interface 104 is configured to be coupled between the component 101 and a sensor. For example, the component 101 can include a scintillator and the optical interface 104 can facilitate optical coupling between a photosensor 206 (see FIG. 8) and the scintillator.

In an embodiment, the optical interface 104 can include a window 52, an optical coupler 54, or both the window 52 and the optical coupler 54. The window 52 can include a transparent material such as a glass, a sapphire, or an aluminum oxynitride. The optical coupler 54 can include a polymer, such as a silicone rubber or an epoxy, that is polarized to align the reflective indices of the scintillator and the window 52. In other embodiments, the optical coupler 54 can include gels or colloids that include polymers and additional elements.

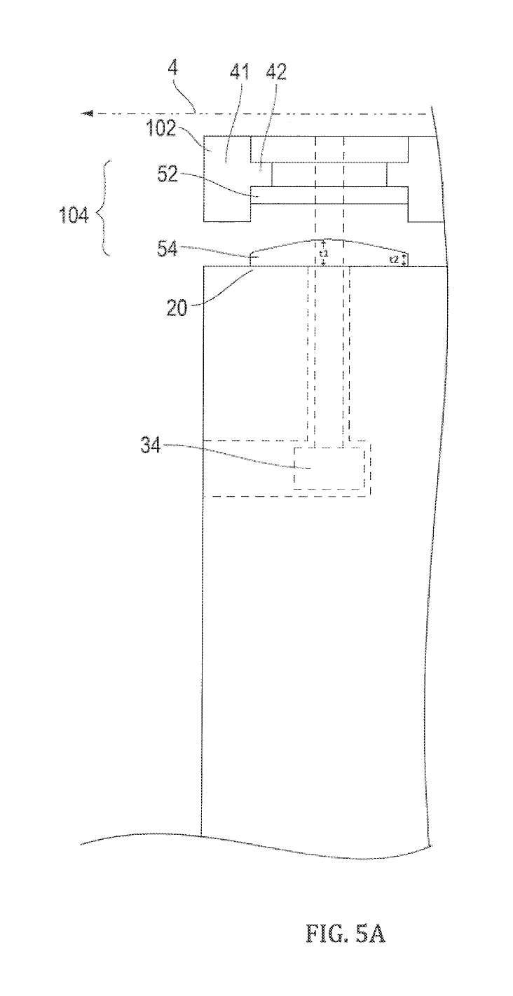

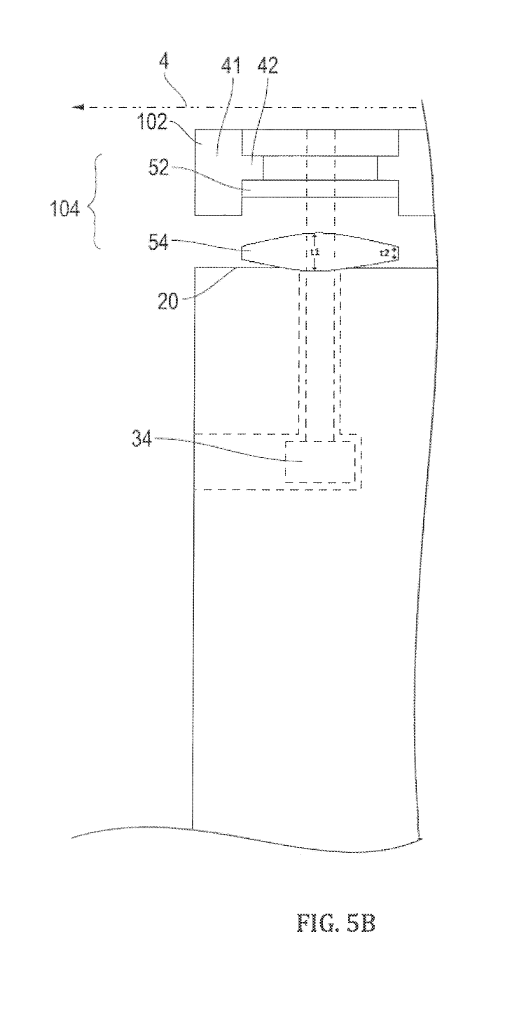

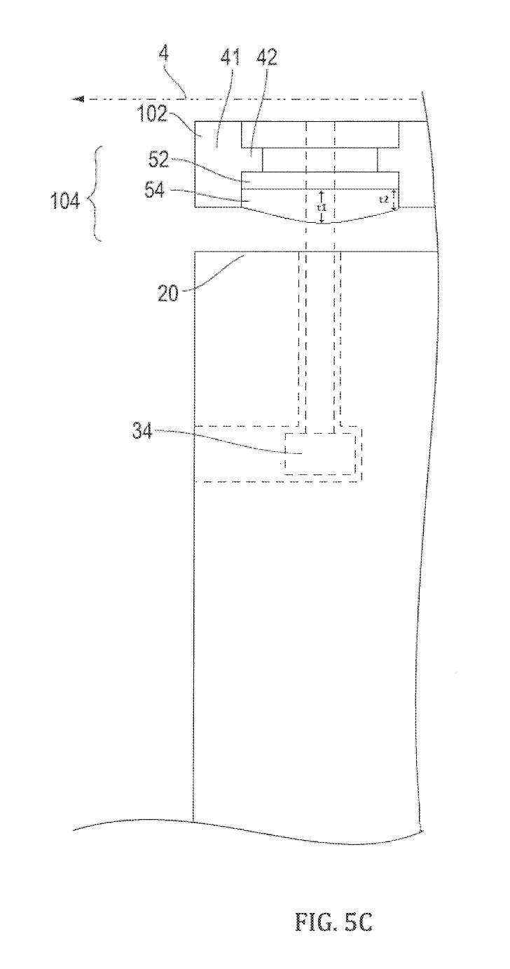

As illustrated in FIGS. 5A-5C, the optical coupler 54 can include a first thickness t1 and a second thickness t2. The first thickness t1 is located near the center of the optical coupler 54. The second thickness t2 is located near an edge of the optical coupler 54. In one embodiment, the first thickness t1 is greater than the second thickness t2 before the compression member 102 and the optical interface 104 are secured to a component 101 via fastening members 24 (not illustrated in FIG. 5A) extending into openings in a component 101. In one embodiment, the first thickness t1 prior to compression is between 1 mm and 5 mm and the thickness of t2 prior to compression is between 1 mm-3 mm. In one embodiment, the first thickness t1 is 3 mm and the second thickness t2 is 2 mm. In another embodiment, the first thickness t1 is 2.5 mm and the second thickness t2 is 1.5 mm. In yet another embodiment, the first thickness t1 is 2 mm and the second thickness t2 is 1 mm. In one embodiment, the optical coupler is adhered to the surface 20 of the component 101 before being coupled to the window 52, as seen in FIG. 5A. In another embodiment, the optical coupler 54 is adhered to the window 52 before being coupled to the component 101, as seen in FIG. 5C. The optical coupler 54 can include one or more convex surfaces before being compressed. In one embodiment, the optical coupler 54 has a double convex shape (convex surfaces along opposite sides of the optical coupler) before the compression member 102 and the optical interface 104 are secured to a component 101. After the optical interface 104 and compression member 102 are secured to the component 101 via fastening members 24, the first thickness t1 provides an area able to maintain a good interface connection between the optical interface 104 and the component 101 during varying temperature changes. Specifically, the optical coupler 54 includes a convex surface that provides an area able to withstand higher pressures as temperatures decrease below 22° C. From a top view, the optical coupler 54 can be a polygonal (e.g. rectangular, triangular, hexagonal), circular, ellipse, or any other geometric shape. In operation, after the optical interface 104 and compression member 102 are secured to the component 101 via fastening members 24, the first thickness t1 is within between 0.1 mm to 0.5 mm of the second thickness t2.

The compression member can have a body 41 and a flange 42 extending from the body 41. The flange can extend over the component so as to form a receiving cavity 40 between the flange 42 and surface 20 of the component 101. As illustrated in FIGS. 4 and 5, a portion of the optical interface 104 can be disposed in the receiving cavity 40 formed by the compression member flange 42. In an embodiment, the compression member 102 is secured by the fastening members 24 and 34, which in turn secures the optical interface 104 on the surface 20 of the component 101.

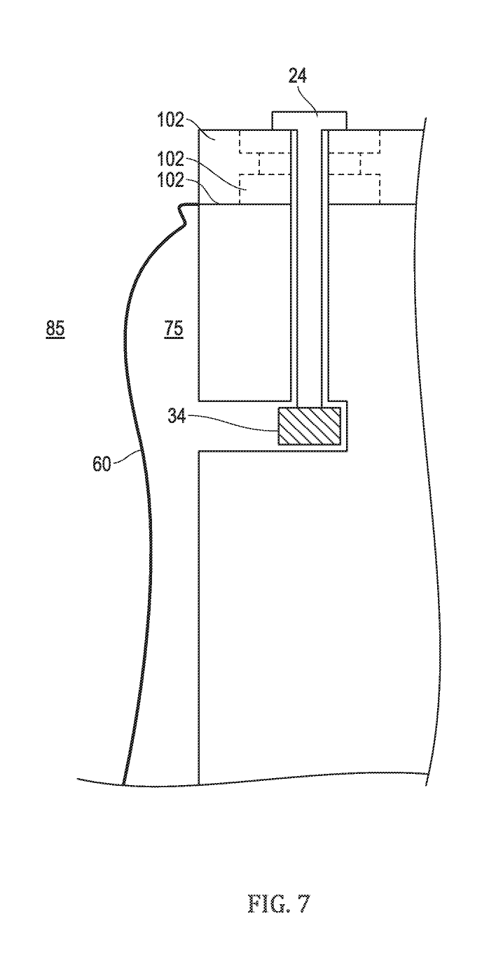

As illustrated in FIG. 7, a moisture barrier 60 can be disposed adjacent the component 101. The moisture barrier 60 can be a pliable moisture barrier. As used herein, the term “pliable” refers to a material that is compliant and will readily conform to the general shape and contours of the component. The moisture barrier 60 can reduce the passage of fluid, such as water vapor, or the water gain within the moisture barrier. For example, the moisture barrier 60 can separate an inner region 75 from an outer region 85. The moisture barrier 60 can be configured to limit or prevent moisture from entering the inner region 75. In an embodiment, the fastening member 24 is partly within the inner region 75 and partly within the outer region 85. In an embodiment, the fastening member 34 is completely within the inner region 75, and the fastening member 34 does not extend into the outer region 85.

The moisture barrier 60 can at least partially encapsulate the component 101. In an embodiment, the moisture barrier 60 may not completely encapsulate the component 101. For example, the moisture barrier 60 may not be transmissive to certain types of light. Thus, in an embodiment where the component 101 is intended to receive or transmit light, such as a scintillator in a radiation detector, the moisture barrier 60 may define a gap to allow transmission of such light. The optical interface 104, secured by the compression member 102, can overlie the gap in the moisture barrier 60 to permit transmission of light while maintaining a moisture seal that limits or prevents the transmission of moisture to the inner region 75. Where there is a gap in the moisture barrier along the surface 20 of the component 101, the inner region can be defined by the surface 20.

In a particular embodiment using a transparent plastic scintillator as the component 101, exposing the component 101 to moisture can also reduce the transparency of the plastic. The moisture barrier 60 can assist to reduce haze and retain significant visible light transmission properties of the plastic scintillator. For example, the scintillator can have a visible light transmission at least 65%, at least 70%, or at least 75% after an exterior of the moisture barrier 60 is exposed to a 55° C. environment at 80% humidity for 400 hours. In other embodiments, the scintillator 101 may have a visible light transmission no greater than 99%, no greater than 97%, or no greater than 95% after an exterior of the moisture barrier 104 is exposed to a 55° C. environment at 80% humidity for 400 hours. The visible light transmission is measure according to ASTM D1003-13 (2013).

The moisture barrier 60 can include at least one water-resistant layer that decreases the vapor transmission rate of the moisture barrier. The vapor transmission rate is measured according to ASTM E 96-16 (2016) or F 1249-13 (2013). In an embodiment, the moisture barrier 60 may have a vapor transmission rate of no greater than 5×10−11 g/cm2/s, no greater than 3×10−11 g/cm2/s, or no greater than 1.1×10−11 g/cm2/s. In an embodiment, the moisture barrier 60 can have a vapor transmission rate of at least 1×10−15 g/cm2/s, at least 1×10−14 g/cm2/s, or even at least 1.1×10−13 g/cm2/s.

In an embodiment, the water-resistant layer can include a metal. The metal can include an atomic metal, a metal alloy, a metal oxide, or any combination thereof. The metal can have a low atomic number. For example, the metal can include a metal having an atomic number of no greater than 34. In particular embodiments, the metal can include an aluminum, a copper, or a combination thereof. In further embodiments, the water-resistant layer can be a continuous layer, the continuous layer can include a foil, such as a metal foil. The continuous layer or metal foil can include the metal discussed above. The continuous layer can provide superior performance compared to a deposited or sprayed-on metal film.

In addition to the water-resistant layer, the moisture barrier 60 can include at least one polymer layer, at least two polymer layers, at least three polymer layers, or at least four polymer layers. In an embodiment, at least one of the polymer layers can include a thermoplastic polymer. The thermoplastic polymer can assist in forming a seal or a seam on the moisture barrier. In a particular embodiment, the thermoplastic polymer can include a polyethylene, such as a liner low density polyethylene.

In further embodiments, at least one of the polymer layers can include a polyester. In a particular embodiment, the polyester can include a semi-aromatic polyester. The semi-aromatic polyester can include, for example, a polyethylene terephthalate, a polybutylene terephthalate, a polytrimethylene terephthalate, a polyethylene naphthalate, or any combination thereof. In another particular embodiment, the at least one polymer layer including a polyester can form an outermost layer of the moisture barrier. In an embodiment, the polymer layer comprising the polyester can be a protective layer and can contribute to the water-resistance of the moisture barrier.

The water-resistant layer can be disposed between polymer layers. For example, the moisture barrier 60 can include at least one polymer layer on a first side of the water-resistant layer and at least one polymer layer on an opposite second side of the water-resistant layer. In an embodiment, the moisture barrier 60 can include at least two polymer layers on a first side of the water-resistant layer and at least two polymer layers on an opposite second side of the water-resistant layer. In an embodiment, the at least two polymer layers on the first side of the water-resistant layer can include a first polymer layer comprising a first polymer and a second polymer layer comprising a second polymer that is different that the first polymer. Further, in an embodiment, each of the at least two polymer layers on the second side of the water-resistant layer can include a third polymer layer comprising a third polymer and a fourth polymer layer comprising a fourth polymer that is different than the third polymer. In a particular embodiment, the polymer layers nearest the water-resistant layer can assist in protecting the water-resistant properties of the water-resistant layer.

In an embodiment, the moisture barrier 60 can be formed by wrapping the component 101 with at least one sheet comprising the water-resistant layer and then coating the water-resistant layer with a polymer or ceramic coating material. The coating material can be applied to the component 101 using a dip coating process, a brush coating process, a spray coating process, a chemical vapor deposition process, a physical vapor deposition process, or a process of dispersing and activating an expandable powder on the water-resistant layer. In certain embodiments, the water-resistant layer can be taped down after wrapping the component 101 and prior to coating with the polymer or ceramic coating, particularly during a spray coating. In an embodiment, moisture barrier 60 can further comprise a desiccant, or other moisture absorbing or adsorbing material, within the inner region to assist in reducing the water interacting with the scintillator in the interior of the moisture barrier.

In an embodiment, the moisture barrier 60 can be a fluid barrier that functions as a barrier to other fluids, including gases such as oxygen. In particular embodiments, the moisture barrier 60 can include an oxygen getter.

In a conventional apparatus, the mechanism for securing an optical interface can loosen over time and degrade the moisture seal. For example, a plastic scintillator can include a water-sensitive material and can exhibit creep deformation after exposure to stress or extreme temperature over time. Thus, a fastening member inserted into the plastic scintillator can loosen due to the creep of the plastic scintillator material. Surprisingly, the securing mechanism of embodiments of this disclosure can maintain compression such that the compression member exhibits a displacement of no greater than 0.05 cm, or no greater than 0.03 cm, or no greater than 0.01 cm after at least 50 thermocycles, or at least 75 thermocycles, or at least 100 thermocycles. In a particular embodiment, the compression member can exhibit no displacement after at least 50 thermocycles, or at least 75 thermocycles, or at least 100 thermocycles. In an embodiment, a thermocycle can have a temperature range with a low endpoint of −40° C., or −30° C., or −20° C., and a high end point of 35° C., or 45° C., or 55° C. A thermocycle can have a temperature range having any of the above values, such as a range of −20° C. to 35° C., or −30° C. to 45° C., or −40° C. to 55° C. In each thermocycle, the temperature is ramped up in a chamber at 6° C./min and has a 2 hour soak at each end point.

As used herein, the term “displacement” refers to distance an article has moved from its original position. With respect to displacement of the compression member 102, the term “displacement” refers to the distance the compression member has moved from is original position with respect to surface 20 of the component 101. Further, the term “no displacement” refers to a displacement of no greater than 0.008 cm.

In an embodiment, the apparatus can include a seal between the outer region 85 and the inner region 75 at least partly defined by the pliable moisture barrier. The component 101 can be disposed in the inner region 75. In an embodiment, the seal can exhibit a vapor transmission rate of no greater than 5×10−11 g/cm2/s, or no greater than 3×10−11 g/cm2/s, or no greater than 1.1×10−11 g/cm2/s. In an embodiment, the seal can exhibit a vapor transmission rate of at least 1×10−15 g/cm2/s, or at least 1×10−14 g/cm2/s, or at least 1.1×10−13 g/cm2/s. The vapor transmission rate is measured according to ASTM E 96-16 (2016) or F 1249-13 (2013). In a particular embodiment, the seal can include a hermetic seal between the outer region 85 and the inner region 75.

In an embodiment, the seal can exhibit improved sealing properties over time. For example, the apparatus can limit the increase of its vapor transmission rate across the seal to no greater than 1%, or no greater than 0.5%, or no greater than 0.1% over a given number of thermocycles. The number of thermocycles can be at least 50 thermocycles, or at least 75 thermocycles, or at least 100 thermocycles. The thermocycles can be the same timing and temperature ranges as the thermocycles discussed previously with respect to displacement of the compression member.

A radiation detector can include one or more of the elements discussed above. In addition, the radiation detector can include a photosensor, an analyzer device, or a combination thereof where the analyzer device can be electrically coupled to the photosensor. The photosensor 206 can include a photomultiplier tube (PMT), a semiconductor-based photomultiplier, an avalanche photodiode, a hybrid photosensor, or a combination thereof. As used herein, a semiconductor-based photomultiplier is intended to mean a photomultiplier that includes a plurality of photodiodes, wherein each of the photodiodes have a cell size less than 1 mm, and the photodiodes are operated in Geiger mode. In practice, the semiconductor-based photomultiplier can include over a thousand photodiodes, wherein each photodiode has a cell size in a range of 10 microns to 100 microns and a fixed gain. The output of the semiconductor-based photomultiplier is the sum signal of all Geiger mode photodiodes. The semiconductor-based photomultiplier can include silicon photomultiplier (SiPM) or a photomultiplier based on another semiconductor material. For a higher temperature application (e.g., higher than 125° C.), the other semiconductor material can have a wider bandgap energy than silicon. An exemplary material can include SiC, a Ga-Group V compound (e.g., GaN, GaP, Ga2O3, or GaAs), or the like. An avalanche photodiode has a larger size, such as a light-receiving area of least 1 mm2 and is operated in a proportional mode.

As illustrated in FIG. 8, the analyzer device 308 can include hardware and can be at least partly implemented in software, firmware, or a combination thereof. In an embodiment, the hardware can include a plurality of circuits within an field-programmable gate array (FPGA), an application-specific integrated circuit (ASIC), another integrated circuit or on a printed circuit board, or another suitable device, or any combination thereof. The analyzer device 308 can also include a buffer to temporarily store data before the data are analyzed, written to storage, read, transmitted to another component or device, another suitable action is performed on the data, or any combination thereof.

The analyzer device 308 can include an amplifier 322 coupled to the photosensor 206, such that an electronic pulse from the photosensor 206 can be amplified before analysis. The amplifier 322 can be coupled to an analog-to-digital converter (ADC) 324 that can digitize the electronic pulse. The ADC 324 can be coupled to a pulse shape discrimination (PSD) module 342. In a particular embodiment, the PSD module 342 can include a FPGA or an ASIC. In a particular embodiment, the PSD module 342 can include circuits to analyze the shape of the electronic pulse and determine whether the electronic pulse corresponds to a neutron or gamma radiation. In a more particular embodiment, the PSD module 342 can use the electronic pulse and temperature from a temperature sensor with a look-up table to determine whether the electronic pulse corresponds to a neutron or gamma radiation. The look-up table can be part of the FPGA or ASIC or may be in another device, such as an integrated circuit, a disk drive, or a suitable persistent memory device.

The analyzer device 308 can include a neutron counter 362 and a gamma radiation counter 364. If the PSD module 342 determines that an electronic pulse corresponds to a neutron, the PSD module 342 increments the neutron counter 362. If the PSD module 342 determines that an electronic pulse corresponds to gamma radiation, the PSD module 342 increments the gamma radiation counter 364. While FIG. 8 illustrates a dual mode radiation detector, in other embodiments the radiation detector could be single mode radiation detector and the analyzer could include only one of the neutron counter 362 or the gamma radiation counter 364.

In an embodiment, the radiation detector can include one of a security detection apparatus, an well-logging detection apparatus, a gamma ray spectroscopy apparatus, an isotope identification apparatus, Single Positron Emission Computer Tomography (SPECT) analysis apparatus, a Positron Emission Tomography (PET) analysis apparatus, and an x-ray imaging apparatus.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

Embodiment 1. An apparatus comprising: a component including a water-sensitive material; a compression member; and a fastener system including: a first fastening member extending through the compression member and into the component; and a second fastening member within the component and coupled to the first fastening member.

Embodiment 2. An apparatus comprising: a component including a water-sensitive material; a fastener system including: a first fastening member extending into the component; and a second fastening member within an opening in the component and coupled to the first fastening member; and a pliable moisture barrier that separates an inner region from an outer region; wherein the component and the second fastening member are completely within the inner region, and the first fastening member is partly within the inner region and partly within the outer region.

Embodiment 3. An apparatus comprising: a component including a luminescent material and having first and second openings and first and second surfaces; a fastener system including: a first fastening member within the first opening in the component; and a second fastening member within the second opening in the component and coupled to the first fastening member; wherein the first opening extends into the component from the first surface, and the second opening extends into the component from the second surface.

Embodiment 4. An apparatus comprising: a component including a plastic material; a compression member attached to the component; and wherein or the compression member exhibits no displacement, after 100 thermocycles, each thermocycle having a temperature range of −40° C. to 55° C.

Embodiment 5. A component comprising a luminescent material, and having: a first opening that extends into the component from a first surface of the component, and a second opening that extends into the component from a second surface of the component, the first opening intersecting with the second opening.

Embodiment 6. The apparatus of any one of embodiments 1, 2, or 4, wherein the component has a first opening that extends into the component from a first surface of the component, the component has a second opening that extends into the component from a second surface of the component, and the first opening intersects with the second opening.

Embodiment 7. The component of embodiment 5 or the apparatus of embodiments 3 or 6, wherein the first surface is contiguous with the second surface.

Embodiment 8. The apparatus or component of any one of embodiments 5 to 7, wherein at least one of the first and second openings defines a linear channel extending into the component.

Embodiment 9. The apparatus or component of any one of embodiments 5 to 8, wherein the first opening intersects with the second opening at an angle that is a right angle or an oblique angle, relative to a central axis of the first opening.

Embodiment 10. The apparatus or component of embodiment 9, wherein the angle is at least 75°, or at least 80°, or at least 85°, relative to a central axis of the first opening.

Embodiment 11. The apparatus or component of any one of embodiments 9 and 10, wherein the angle is at most 105°, or at most 100°, or at most 95°, relative to a central axis of the first opening.

Embodiment 12. The apparatus or component of any one of embodiments 3 and 8 to 10, wherein the angle is in a range of 75° to 105°, 80° to 100°, or 85° to 95°.

Embodiment 13. The apparatus or component of any one of the preceding embodiments, wherein a first fastening member extends into the component from a first surface of the component.

Embodiment 14. The apparatus or component of any one of the preceding embodiments, wherein a second fastening member is within the component.

Embodiment 15. The apparatus or component of any one of embodiment 14, wherein the first fastening member contacts the second fastening member.

Embodiment 16. The apparatus or component of any one of embodiments 14 and 15, wherein the first fastening member is coupled to the second fastening member.

Embodiment 17. The apparatus or component of any one of embodiments 14 to 16, wherein the first fastening member extends into the second fastening member.

Embodiment 18. The apparatus or component of any one of embodiments 14 to 17, wherein the first fastening member is in threaded engagement with the second fastening member.

Embodiment 19. The apparatus or component of any one of embodiments 14 to 18, wherein the first fastening member is a bolt or a screw, and the second fastening member is a cross dowel or a nut.

Embodiment 20. The apparatus or component of any one of embodiments 5 to 19, wherein a length of the first opening is different from a length of the second opening.

Embodiment 21. The apparatus or component of embodiment 20, wherein the length of the first opening is greater than the length of the second opening.

Embodiment 22. The radiation detector or scintillator of any one of embodiments 14 to 20, wherein a length of the first fastening member is different from a length of the second fastening member.

Embodiment 23. The radiation detector or scintillator of embodiment 22, wherein the length of the first fastening member is greater than the length of the second fastening member.

Embodiment 24. The apparatus or component of any one of embodiments 14 to 23, wherein a length of the first fastening member is greater than a length of the first opening extending into the component.

Embodiment 25. The apparatus or component of any one of embodiments 14 to 24, wherein a length of the second fastening member is less than a length of the second opening.

Embodiment 26. The apparatus or component of any one of embodiments 14 to 25, wherein the second fastening member is completely within the component.

Embodiment 27. The apparatus or component of any one of embodiments 14 to 26, wherein the first fastening member protrudes from the component when the first fastening member is engaged with the second fastening member.

Embodiment 28. The apparatus or component of any one of embodiments 14 to 27, wherein the second fastening member is completely within the component when the first fastening member is engaged with the second fastening member.

Embodiment 29. The apparatus or component of any one of embodiments 1, 2, 4, and 6 to 28, wherein the component comprises a luminescent material.

Embodiment 30. The apparatus or component of any one of embodiments 1, 2, 4, and 6 to 29, wherein the component comprises a scintillator material.

Embodiment 31. The apparatus or component of any one of embodiments 1, 2, 3, and 5 to 30, wherein the component comprises a plastic material.

Embodiment 32. The apparatus or component of embodiment 31, wherein the plastic material comprises a plastic matrix having scintillator particles dispersed therein.

Embodiment 33. The apparatus or component of embodiment 31, wherein the plastic material comprises an organic scintillator material.

Embodiment 34. The apparatus or component of embodiment 33, wherein the organic scintillator material comprises 2,5-diphenyloxazole, 1,4-bis-2-(5-phenyloxazolyl)-benzene), terphenyl, 1,1,4,4-tetraphenylbutadiene, a tris complex of 2,6-pyridine dicarboxylic acid (dipicolinic acid, DPA), an Ir(mppy)3, an iridium-tris[2-(4-totyl)pyridinato-NC2], a pyrazolate-bridged cyclometalated platinum(II) complex, or any combination thereof.

Embodiment 35. The apparatus of any one of embodiments 1 to 4 and 6 to 34, further comprising an optical interface.

Embodiment 36. The apparatus of embodiment 35, wherein the optical interface comprises a window.

Embodiment 37. The apparatus of embodiment 36, wherein the window comprises a glass, a sapphire, or an aluminum oxynitride.

Embodiment 38. The apparatus of any one of embodiments 35 to 37, wherein the optical interface comprises an optical coupler between the window and the first surface of the scintillator.

Embodiment 39. The apparatus of embodiment 38, wherein the optical coupler comprises a silicone or an epoxy.

Embodiment 40. The apparatus of any one of embodiments 2, 3, and 6 to 39, further comprising a compression member.

Embodiment 41. The apparatus of embodiments 1, 4, and 6 to 40, wherein the compression member couples an optical interface to a surface of the component.

Embodiment 42. The apparatus of embodiment 41, wherein the compression member partially overlies the optical interface.

Embodiment 43. The apparatus of any one of embodiments 40 to 42, wherein a first fastening member extends through the compression member and into the component.

Embodiment 44. The apparatus or component of any one of embodiments 3 to 43, wherein the component comprises a water-sensitive material.

Embodiment 45. The apparatus of any one of embodiments 1 and 3 to 44, further comprising a pliable moisture barrier coupled to the component.

Embodiment 46. The apparatus of embodiment 45, wherein the pliable moisture barrier separates an inner region from an outer region, wherein the component is completely within the inner region.

Embodiment 47. The apparatus of embodiment 46, wherein the first fastening member is partly within the inner region and partly within the outer region.

Embodiment 48. The apparatus of any one of embodiments 45 and 46, wherein the second fastening member is completely within the inner region.

Embodiment 49. The apparatus of any one of embodiments 1 to 3 and 6 to 48, wherein a compression member exhibits a displacement of no greater than 0.05 cm, or no greater than 0.03 cm, or no greater than 0.01 cm after at least 50 thermocycles, or at least 75 thermocycles, or at least 100 thermocycles, each thermocycle having a temperature range of −40° C. to 55° C.

Embodiment 50. The apparatus of any one of embodiments 1 to 3 and 6 to 49, wherein a compression member exhibits no displacement after at least 50 thermocycles, or at least 75 thermocycles, or at least 100 thermocycles, each thermocycle having a temperature range of −40° C. to 55° C.

Embodiment 51. The apparatus of any one of the preceding embodiments, wherein the apparatus includes a seal between an outer region and an inner region, the component disposed in the inner region and the seal being at least partly defined by a pliable moisture barrier.

Embodiment 52. The apparatus of embodiment 51, wherein the seal exhibits a vapor transmission rate of no greater than 5×10−11 g/cm2/s, or no greater than 3×10−11 g/cm2/s, or no greater than 1.1×10−11 g/cm2/s.

Embodiment 53. The apparatus of any one of embodiments 51 and 52, wherein the seal is a hermetic seal.

Embodiment 54. The apparatus of any one of embodiments 51 to 53, wherein the seal has an increase in vapor transmission rate of no greater than 1%, or no greater than 0.5%, or no greater than 0.1% over at least 50 thermocycles, or at least 75 thermocycles, or at least 100 thermocycles, each thermocycle having a temperature range of −40° C. to 55° C.

Embodiment 55. The apparatus of any one of embodiments 1 to 4 and 6 to 49, wherein the apparatus is a radiation detector.

Embodiment 56. The apparatus of embodiment 54, wherein the radiation detector comprises a photosensor and an analyzer device electrically coupled to the photosensor.

Embodiment 57. The apparatus of embodiment 55, wherein the radiation detector includes one of a security detection apparatus, an well-logging detection apparatus, a gamma ray spectroscopy apparatus, an isotope identification apparatus, Single Positron Emission Computer Tomography (SPECT) analysis apparatus, a Positron Emission Tomography (PET) analysis apparatus, and an x-ray imaging apparatus.

Embodiment 58. The apparatus of any of the embodiments 38 to 57, wherein the optical coupler has a first thickness greater than a second thickness and wherein the first thickness is near the center of the optical coupler and the second thickness is at the edge of the optical coupler.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An apparatus comprising:
a component including a water-sensitive material;
a compression member; and
a fastener system including:
a first fastening member extending through the compression member and into the component; and
a second fastening member within the component and coupled to the first fastening member.

2. The apparatus of claim 1, wherein the component comprises:
a first opening that extends into the component from a first surface of the component, and
a second opening that extends into the component from a second surface of the component, wherein the first opening intersects with the second opening.

3. The apparatus of claim 2, further comprising an optical interface, wherein the optical interface comprises a window and an optical coupler disposed between the window and the first surface of the component.

4. The apparatus of claim 3, wherein the optical coupler has a first thickness greater than a second thickness and wherein the first thickness is near the center of the optical coupler and the second thickness is at the edge of the optical coupler.

5. The apparatus of claim 2, wherein the first opening intersects with the second opening at an angle that is in a range of 75° to 105°.

6. The apparatus of claim 2, wherein the first opening intersects with the second opening at an angle that is in a range of 80° to 100°.

7. The apparatus of claim 2, wherein the first opening intersects with the second opening at an angle that is in a range of 85° to 95°.

8. The apparatus of claim 1, wherein the second fastening member is completely within the component.

9. The apparatus of claim 1, wherein the first fastening member protrudes from the component when the first fastening member is engaged with the second fastening member.

10. The apparatus of claim 1, wherein the component comprises a scintillator material.

11. An apparatus comprising:
a component including a plastic material; and
a compression member attached to the component, wherein the compression member exhibits no displacement after 100 thermocycles, each thermocycle having a temperature range of −40° C. to 55° C.

12. The apparatus of claim 11, further comprising a pliable moisture barrier coupled to the component.

13. The apparatus of claim 12, wherein the apparatus includes a hermetic seal between an outer region and an inner region, the component disposed in the inner region and the seal being at least partly defined by a pliable moisture barrier.

14. The apparatus of claim 13, wherein the seal has an increase in vapor transmission rate of no greater than 1% over at least 100 thermocycles.

15. The apparatus of claim 11, wherein the apparatus is a radiation detector.

16. A component comprising a luminescent material, and having:
a first opening that extends into the component from a first surface of the component, and
a second opening that extends into the component from a second surface of the component, the first opening intersecting with the second opening.

17. The component of claim 16, further comprising a pliable moisture barrier coupled to the component.

18. The apparatus of claim 17, wherein the apparatus includes a hermetic seal between an outer region and an inner region, the component disposed in the inner region and the seal being at least partly defined by a pliable moisture barrier.

19. The apparatus of claim 18, wherein the seal has an increase in vapor transmission rate of no greater than 0.1% over at least 100 thermocycles, each thermocycler having a temperature range of −40° C. to 55° C.

20. The apparatus of claim 16, further comprising an optical interface, wherein the optical interface comprises a window and an optical coupler disposed between the window and the first surface of the component.
